(19) United States
(12) Patent Application Publication
(10) Pub. No.: US 2013/0328397 A1
(43) Pub. Date: Dec. 12, 2013

(54) ENERGY STORAGE SYSTEM

(71) Applicant: SAMSUNG SDI CO., LTD., Yongin-si (KR)

(72) Inventor: Woog-Young Lee, Yongin-si (KR)

(73) Assignee: SAMSUNG SDI CO., LTD., Yongin-si (KR)

(21) Appl. No.: 13/625,603

(22) Filed: Sep. 24, 2012

(30) Foreign Application Priority Data
Jun. 11, 2012 (KR) 10-2012-0062346

(51) Int. Cl. H02J 4/00

(52) U.S. Cl. 307/23

(57) ABSTRACT

An energy storage system, more particularly, a grid-connected energy storage system including a renewable energy generation system. The energy storage system includes a compensation unit for storing or outputting electric energy generated from a renewable energy generation system including a plurality of renewable energy generation modules; and a power managing system for converting power generated from the renewable energy generation system into power for driving a load, outputting the load, and operating the compensation unit when a mismatch loss is generated so that entire output power from the renewable energy generation system is smaller than the sum of maximum power of the renewable energy generation modules. In this regard, when a mismatch loss is generated and thus entire output power from a renewable energy generation system is smaller than the sum of maximum power, the mismatch loss of a renewable energy generation system is compensated for such that the generation efficiency of the renewable energy generation system is not reduced, thereby preventing reduction of lifetime of the renewable energy generation system.

### CLAIM OF PRIORITY

This application claims the benefit of Korean Patent Application No. 10-2012-0062346, filed on Jun. 11, 2012, in the Korean Intellectual Property Office, the disclosure of which is incorporated herein in its entirety by reference.

### BACKGROUND OF THE INVENTION

1. Field of the Invention

One or more embodiments of the present invention relate to an energy storage system, and more particularly, to a grid-connected energy storage system including a renewable energy generation system.

2. Description of the Related Art

As problems such as environmental contamination and resource exhaustion have increased, the interest in systems for efficiently using the stored energy has also increased. There is also increased interest in renewable energy obtained via solar photovoltaic power generation and so on. In particular, since renewable energy is obtained from unlimited natural sources, such as sunlight, wind power, tidal power, and so on and little pollution is caused during power generation of renewable energy, research has been actively conducted into methods of producing and using renewable energy.

Recently, research has been conducted into smart grid systems for increasing the energy efficiency by connecting information technology devices to an existing power grid and interactively exchanging information between a power supplier and a consumer.

### SUMMARY OF THE INVENTION

One or more embodiments of the present invention include an energy storage system in which, when a mismatch loss is generated such that entire output power from a renewable energy generation system is smaller than the sum of maximum power of renewable energy generation modules, the mismatch loss of a renewable energy generation system is compensated for such that the generation efficiency of the renewable energy generation system is not reduced, thereby preventing reduction of lifetime of the renewable energy generation system.

Additional aspects will be set forth in part in the description which follows and, in part, will be apparent from the description, or may be learned by practice of the presented embodiments.

According to one or more embodiments of the present invention, an energy storage system includes a compensation unit for storing or outputting electric energy generated from a renewable energy generation system including a plurality of renewable energy generation modules; and a power managing system for converting power generated from the renewable energy generation system into power for driving a load, outputting the load, and operating the compensation unit when a mismatch loss is generated whereby entire output power from the renewable energy generation system is smaller than the sum of maximum power of the renewable energy generation modules.

The compensation unit may include an energy storage unit for storing electric energy generated from the renewable energy generation system; and a controller for outputting energy of the energy storage unit to the power managing system according to a mismatch signal generated from the power managing system.

The controller may store electric energy in the energy storage unit according to a mismatch termination signal from the power managing system.

The energy storage unit may be a super capacitor.

The controller may be a switching unit that is turned on according to the mismatch signal generated from the power managing system and outputs energy of the energy storage unit to the power managing system.

The compensation unit may be configured in such a way that one end of the switching unit is connected to an output end of the renewable energy generation system, other end of the switching unit is connected to one end of the super capacitor, one end of the super capacitor is connected to the other end of the switching unit, and other end of the super capacitor is connected to ground.

The switching unit may be turned on for a predetermined period of time according to a mismatch termination signal so as to charge the super capacitor with the electric energy.

The power managing system may include a maximum power point tracking (MPPT) converter for measuring power generated from the renewable energy generation system and producing maximum power from the renewable energy generation system; and an integrated controller for operating the compensation unit when a mismatch loss is generated whereby entire output power from the renewable energy generation system, which is measured by the MPPT converter, is smaller than the sum of maximum power of the renewable energy generation modules.

The compensation unit may include a plurality of energy storage units that are respectively connected to a plurality of renewable energy generation modules included in the renewable energy generation system; and a plurality of controllers that are respectively connected to the plurality of energy storage units, and control the energy storage system to output energy of the plurality of energy storage units to the power managing system according to a mismatch signal from the power managing system.

The power managing system may operate the compensation unit corresponding to a renewable energy generation module where the mismatch loss is generated, from among the plurality of renewable energy generation modules.

The plurality of controllers may store electric energy in an energy storage unit of a renewable energy generation module where the mismatch loss is generated, according to a mismatch termination signal from the power managing system.

The compensation unit may include a plurality of switching units having one end connected to an output terminal of each of the plurality of renewable energy generation modules of the renewable energy generation system; and a plurality of super capacitors each having one end connected to the other end of each of the switching units and other end connected to ground.

A switching unit connected to a renewable energy generation module where the mismatch loss is generated may be turned on for a predetermined period of time according to a mismatch termination signal so as to charge a corresponding super capacitor with the electric energy.

According to one or more embodiments of the present invention, an energy storage system includes a plurality of compensation units that are respectively connected to a plurality of renewable energy generation modules included in a renewable energy generation system and store or output electric energy generated from the plurality of renewable energy generation modules; and a power managing system for converting power generated from the renewable energy generation system into power for driving a load, outputting the load, and operating the compensation unit when a mismatch loss is generated whereby entire output power from the renewable energy generation system is smaller than the sum of maximum power of the renewable energy generation modules.

The plurality of compensation units may be connected in series between ground and an output terminal of the plurality of renewable energy generation modules that are configured in such as way that an input terminal of a second renewable energy generation module is connected to an output terminal of a first renewable energy generation module and an input terminal of a third renewable energy generation module is connected to an output terminal of the second renewable energy generation module.

The plurality of compensation units may be connected in parallel between ground and an output terminal of each of the plurality of renewable energy generation modules that are configured in such as way that an output terminal of another renewable energy generation module is connected to an output terminal of a first renewable energy generation module.

The plurality of compensation units may be connected in parallel between ground and an output terminal of each of the plurality of renewable energy generation modules that are configured in such as way that an input terminal of a second renewable energy generation module is connected to an output terminal of a first renewable energy generation module and an input terminal of a third renewable energy generation module is connected to an output terminal of the second renewable energy generation module.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram of a grid-connected energy storage system according to an embodiment of the present invention

FIG. 2 is a flowchart of power and control signals of the grid-connected energy storage system shown in FIG. 1, according to an embodiment of the present invention;

FIG. 3 is a detailed diagram of a compensation unit shown in FIG. 1, according to an embodiment of the present invention;

FIG. 4 is a graph showing a property change of a current-voltage curve according to a reduction in the performance of a PV power generation system shown in FIG. 1, according to an embodiment of the present invention;

FIG. 5 is a block diagram of a grid-connected energy storage system according to another embodiment of the present invention;

FIG. 6 is a block diagram of a grid-connected energy storage system according to another embodiment of the present invention; and

FIG. 7 is a block diagram of a grid-connected energy storage system according to another embodiment of the present invention.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms such as “first” and “second” are used herein merely to describe a variety of constituent elements, but the constituent elements are not limited by the terms. The terms are used only for the purpose of distinguishing one constituent element from another constituent element.

The terms used in the present specification are used for explaining a specific exemplary embodiment, not limiting the present invention. Thus, the expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Hereinafter, the present invention will be described in detail by explaining exemplary embodiments of the invention with reference to the attached drawings. Like reference numerals in the drawings denote like elements.

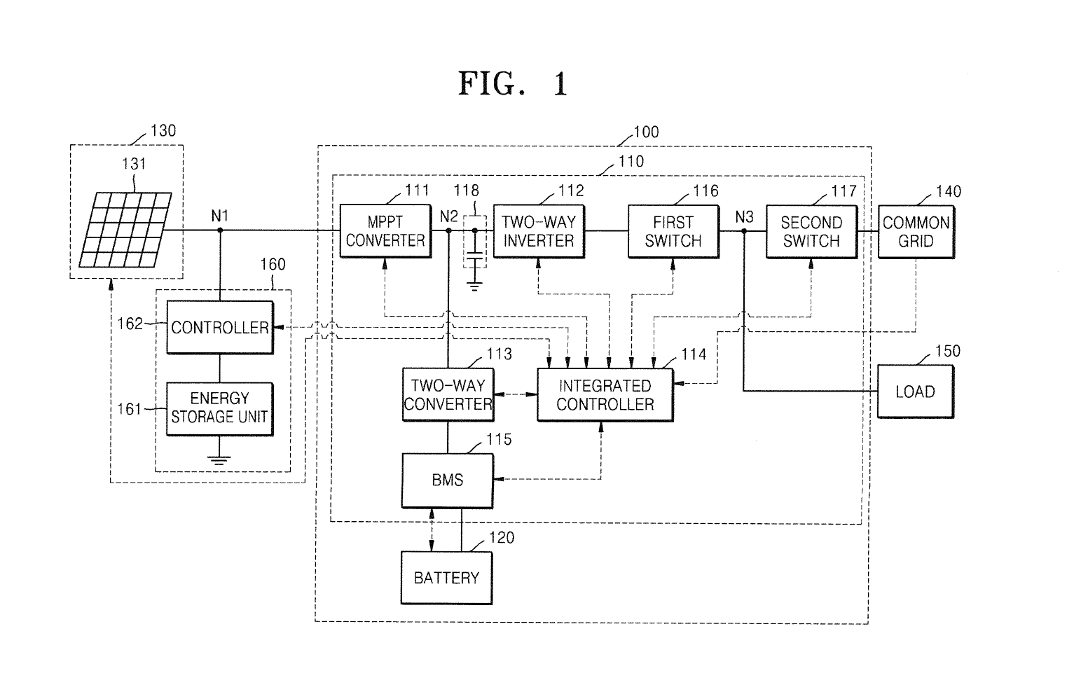

FIG. 1 is a block diagram of a grid-connected energy storage system 100 according to an embodiment of the present invention.

Referring to FIG. 1, a power managing system 110 includes a maximum power point tracking (MPPT) converter 111, a two-way inverter 112, a two-way converter 113, an integrated controller 114, a battery management system (BMS) 115, a first switch 116, a second switch 117, and a direct current (DC) link unit 118. The power managing system 110 is connected to a battery 120, a renewable generation system 130 including a solar battery module 131, a common grid 140, a load 150, and a compensation unit 160. According to an embodiment of the present invention, the grid-connected energy storage system 100 includes the power managing system 110 and the battery 120. However, the present invention is not limited to the terms used herein. For example, the grid-connected energy storage system 100 may be a power managing system or a grid-connected storage system, which includes the power managing system 110 and the battery 120 integrated with each other.

The renewable generation system 130 generates electric energy and outputs the electric energy to the power managing system 110. As shown in FIG. 1, the renewable generation system 130 may include a solar battery module 131. Alternatively, the renewable generation system 130 may be a wind power generating system or a grid power generating system. In addition, the renewable generation system 130 may be any generating system for generating electric energy using renewable energy such as solar heat, geothermal energy, and so one. In particular, it is easy to install a solar battery for generating electric energy by using sunlight in a home, factory, or the like and the solar battery is appropriate for use in conjunction with the grid-connected energy storage system 100 mounted at home. Hereinafter, the renewable generation system 130 is referred to as the photovoltaic (PV) power generation system 130.

The common grid 140 includes a power station, a substation, a transmission line, and so on. When the common grid 140 is in a normal state, power is supplied to the battery 120 or the load 150 according to an on/off state of the first switch 116 and the second switch 117 and receives power supplied from the PV power generation system 130 or the battery 120. When the common grid 140 is in an abnormal state, for example, an abnormal state due to electric work and so one, power supplied from the common grid 140 to the battery 120 or the load 150 and power supplied from the PV power generation system 130 or the battery 120 to the common grid 140 are shut off.

The load 150 consumes power generated by the PV power generation system 130, power stored in the battery 120, or power supplied from the common grid 140 and may be, for example, a home, a factory, or the like.

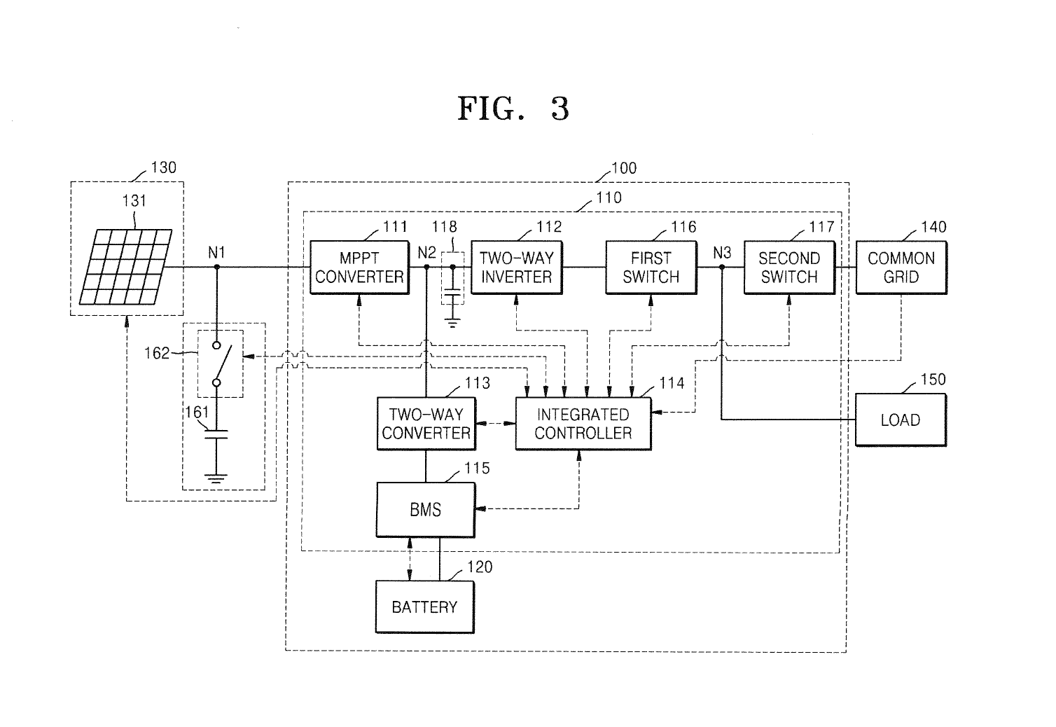

The compensation unit 160 stores or outputs electric energy output from the solar battery module 131 under the control of the power managing system 110. In this case, the electric energy may be output as power or voltage. The compensation unit 160 includes an energy storage unit 161 and a controller 162. The energy storage unit 161 stores and outputs electric energy output from the solar battery module 131. In the present invention, the energy storage unit 161 is, but is not limited to, a super capacitor and may be any element for storing energy. The controller 162 controls the energy storage unit 161 to output electric energy stored in the energy storage unit 161 to the power managing system 110 according to a mismatch generating signal from the power managing system 110. Hereinafter, the compensation unit 160 will be described with reference to FIG. 3.

Since the MPPT converter 111 converts a DC voltage output from the solar battery module 131 to a DC voltage of a second node N2, and the properties of the output of the solar battery module 131 vary according to a climate change and a loading condition based on a quantity of solar radiation and temperature, the controller 162 controls the solar battery module 131 to generate maximum power. That is, the MPPT converter 111 performs both a boost DC-DC converter function and an MPPT controlling function, thereby increasing and outputting an output DC voltage of the solar battery module 131. For example, an MPPT output DC voltage ranges from about 300 V to about 600 V. In addition, the MPPT converter 111 performs MPPT control for generating a maximum power output voltage of the solar battery module 131 according to a change in quantity of solar radiation, temperature, and so on. For example, the MPPT converter 111 may use perturbation and observation (P&O) control, incremental conductance (IncCond) control, power-to-voltage control, and so on. The P&O control is performed by measuring power and voltage of the solar battery module 131 and increasing or reducing a command voltage. The IncCond control is performed by comparing an output conductance and an incremental conductance of the solar battery module 131. The power-to-voltage control is performed by using a slope of a power-to-voltage graph. It will be obvious to one of ordinary skill in the art that other MPPT controlling technologies other than the above-described MPPT control may be used.

The DC link unit 118 is connected in parallel between the second node N2 and the two-way inverter 112. The DC link unit 118 maintains a DC voltage output from the MPPT converter 111 as a DC link voltage, for example, a DC voltage of 380 V and applies the DC voltage to the two-way inverter 112 or the two-way converter 113. In this case, the DC link unit 118 may use an aluminum electrolytic capacitor, a high-pressure polymer capacitor, and a high-pressure and high-current multi layer ceramic capacitor (MLCC). A voltage level of the second node N2 may become instable due to a DC output voltage change of the solar battery module 131, an instantaneous voltage drop of the common grid 140, a peak load generated from the load 150, or the like. Thus, the DC link unit 118 provides a stabilized DC link voltage for a normal operation of the two-way converter 113 and the two-way inverter 112. FIG. 1 shows a case where the DC link unit 118 is a separate element. Alternatively, the DC link unit 118 may be included in the two-way converter 113, the two-way inverter 112, or the MPPT converter 111.

The two-way inverter 112 is connected between the second node N2 and the common grid 140. The two-way inverter 112 converts an output DC voltage of the MPPT converter 111 or an output DC voltage of the two-way converter 113 into an alternating current (AC) voltage of the common grid 140 or the load 150, converts the AC voltage applied from the common grid 140 into a DC voltage and transmits the DC voltage to the second node N2. That is, the two-way inverter 112 performs both an inverter function of converting a DC voltage into an AC voltage and a rectifying function of converting an AC voltage into a DC voltage.

The two-way inverter 112 rectifies an AC voltage that is input from the common grid 140 through the first switch 116 and the second switch 117 to a DC voltage to be stored in the battery 120, outputs the DC voltage, converts a DC voltage output from the PV power generation system 130 or the battery 120 to an AC voltage of the common grid 140, and outputs the AC voltage. The AC voltage output from the common grid 140 may satisfy a power quality standard of the common grid 140, for example, a power factor of 0.9 or more and THD less than 5%. To this end, the two-way inverter 112 may synchronize a phase of an output AC voltage with a phase of the common grid 140 to prevent reactive power from being generated and may adjust an AC voltage level. In addition, the two-way inverter 112 may include a filter for removing harmonics from an AC voltage output from the common grid 140 and may perform other functions, for example, may restrict a voltage variation range, may improve a power factor, may remove a DC component, or may protect transient phenomena. According to an embodiment of the present invention, the two-way inverter 112 performs both an inverter function of converting DC power of the PV power generation system 130 or the battery 120 into an AC power to be supplied to the common grid 140 or the load 150 and a rectifying AC power supplied from the common grid 140 into DC power to be supplied to the battery 120.

The two-way converter 113 is connected between the second node N2 and the battery 120 and converts a DC voltage of the second node N2 into a DC voltage to be stored in the battery 120. In addition, the two-way converter 113 converts a DC voltage stored in the battery 120 into a DC voltage level to be transmitted to the second node N2. For example, when the battery 120 is charged with DC power generated by the PV power generation system 130 or when the battery 120 is charged with AC power supplied to the common grid 140, that is, the battery is in a charge mode, the two-way converter 113 operates as a converter for reducing a DC link voltage level of the second node N2 or a DC link voltage level maintained in the DC link unit 118, for example, a DC voltage of 380 V to a storage voltage of the battery 120, for example, a DC voltage of 100 V. In addition, when power charged in the battery 120 is supplied to the common grid 140 or the load 150, that is, when the battery 120 is in a battery discharge mode, the two-way converter 113 operates as a converter for increasing a battery storage voltage, for example, a DC voltage of 100 V to a DC voltage level or DC link voltage level of the second node N2, for example, a DC voltage of 380 V. According to an embodiment of the present invention, the two-way converter 113 converts DC power generated by the PV power generation system 130 or AC power supplied from the common grid 140 into DC power to be stored in the battery 120, and then converts DC power stored in the battery 120 into DC power to be input to the two-way inverter 112 in order to supply the DC power stored in the battery 120.

The battery 120 stores power supplied from the PV power generation system 130 or the common grid 140. The battery 120 may be configured in such a way that a plurality of battery cells are connected in series or in parallel to each other. A charge or discharge operation of the battery 120 is controlled by the BMS 115 or the integrated controller 114. The battery 120 may include various types of battery cells, for example, nickel-cadmium battery cells, nickel metal hydride (NiMH) battery cells, lithium ion battery cells, lithium polymer battery cells, or the like. The number of battery cells included in the battery 120 may be determined according to a power capacity, a design condition, and so one, which are required by the grid-connected energy storage system 100.

The BMS 115 is connected to the battery 120 and controls a charge or discharge operation of the battery 120 according to control by the integrated controller 114. Discharge power supplied from the battery 120 to the two-way converter 113 and charge power supplied from the two-way converter 113 to the battery 120 are transmitted through the BMS 115. In addition, in order to protect the battery 120, the BMS 115 may perform an overcharge protecting function, an over discharge protecting function, an over current protecting function, an over heat protecting function, a cell balancing function, and so on. To this end, the BMS 115 may detect a voltage, a current, and a temperature of the battery 120, may calculate a state of charge (SOC) and a state of health (SOH), and may monitor a residual power amount, a lifetime, and so on according to the calculating result.

The BMS 115 may include a micro computer for performing a sensing function of detecting a voltage, a current, and a temperature of the battery 120, for determining whether overcharge, over discharge, over current, and cell balancing occur, and for determining a SOH and a SOH, and a protecting circuit for performing functions of preventing charge and discharge, performing a fusing function, and performing a cooling function. As shown in FIG. 1, the BMS 115 includes the power managing system 110 and is separate from the battery 120. Alternatively, the BMS 115 and the battery 120 may be integrated with each other to constitute a battery pack. In addition, the BMS 115 controls a charge or discharge operation of the battery 120 according to control by the integrated controller 114 and transmits information about a charged power amount calculated based on state information of the battery 120, for example, a SOC, to the integrated controller 114.

The first switch 116 is connected between the two-way inverter 112 and a third node N3. The second switch 117 is connected between the third node N3 and the common grid 140. The first switch 116 and the second switch 117 may each use a switch that is turned on or off according to control by the integrated controller 114. The first switch 116 and the second switch 117 shut on or off power supplied from the PV power generation system 130 or the battery 120 to the common grid 140 or the load 150 or power supplied from the common grid 140 to the load 150 or the battery 120. For example, when power generated from the PV power generation system 130 or power stored in the battery 120 is supplied to the common grid 140, the integrated controller 114 turns on the first and second switches 116 and 117. When power is supplied to the load 150 only, the first switch 116 is turned on and the second switch 117 is turned off. In addition, when power of the common grid 140 is supplied to the load 150 only, the first switch 116 is turned off and the second switch 117 is turned on.

When the common grid 140 is an abnormal state, for example, when there is a blackout or a wire is required to be repaired, the second switch 117 shuts off power to the common grid 140 so as to perform a single operation of the grid-connected energy storage system 100 according to control by the integrated controller 114. In this case, since the power managing system 110 is separate from the common grid 140, the integrated controller 114 performs path maintenance or prevents short-range approach accidents such as electric shock of a repairer in the common grid 140, and prevents the common grid 140 from operating in an abnormal state to adversely affecting electric equipment. In addition, when the common grid 140 is an abnormal state, that is, when power generated from the PV power generation system 130 or power stored in the battery 120 is supplied to the load 150 and then the common grid 140 is recovered to a normal state, since a phase error between a voltage of the common grid 140 and an output voltage of the battery 120 that is in a single driving state occurs, the power managing system 110 may be damaged. In this case, the integrated controller 114 may prevent single driving in order to prevent the power managing system 110 from being damaged.

The integrated controller 114 controls an overall operation of the power managing system 110 or the grid-connected energy storage system 100. In the present invention, the integrated controller 114 detects an electrostatic signal of the common grid 140 and performs a control operation for transmitting DC power stored in the battery 120 to the load 150 when receiving the electrostatic signal. In this case, in order to supply power stored in the battery 120 to the load 150, the integrated controller 114 turns off the two-way inverter 112 and the MPPT converter 111 and turns on the two-way converter 113 to perform constant voltage control on a voltage of the second node N2 through power stored in the battery 120 and then turns on the two-way inverter 112 to supply power to the load 150. Alternatively, when the PV power generation system 130 is capable of operating, the PV power generation system 130 may control the MPPT converter 111 to be slowly driven to supply generated power together with power stored in the battery 120 to the load 150. Furthermore, the integrated controller 114 may receive power output from the PV power generation system 130, which is output from the MPPT converter 111, and determines whether a mismatch occurs, that is, the output power of the PV power generation system 130 is smaller than the maximum output power. When a mismatch occurs, the integrated controller 114 may drive the compensation unit 160 to compensate for the mismatch.

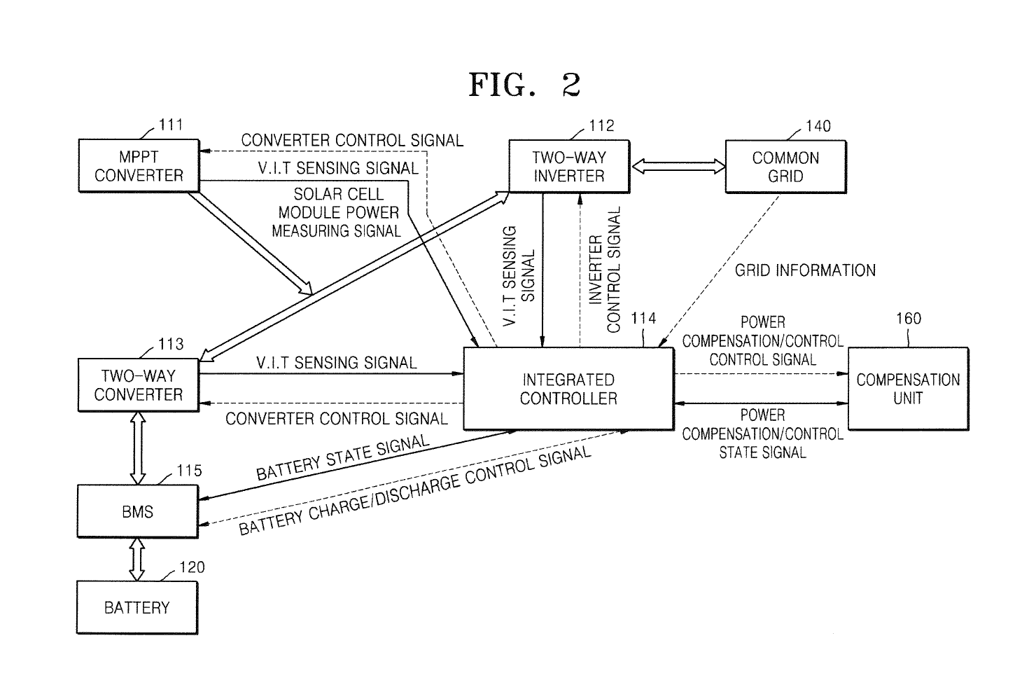

FIG. 2 is a flowchart of power and control signals of the grid-connected energy storage system 100 shown in FIG. 1, according to an embodiment of the present invention.

FIG. 2 shows power flow between internal components the grid-connected energy storage system 100 and control flow of the integrated controller 114. As shown in FIG. 2, a DC voltage converted by the MPPT converter 111 is applied to the two-way inverter 112 and the two-way converter 113, is converted into an AC voltage by the two-way inverter 112, and is applied to the common grid 140. Alternatively, the DC voltage converted by the MPPT converter 111 is converted into a DC voltage to be stored in the battery 120 by the two-way converter 113 and is charged in the battery 120 through the BMS 115. The DC voltage charged in the battery 120 is converted into a DC voltage to be input to the two-way inverter 112 by the two-way converter 113, is converted into an AC voltage satisfying a standard of the common grid 140 in the two-way inverter 112, and is input to the common grid 140.

The integrated controller 114 controls an overall operation of the grid-connected energy storage system 100 and determines an operation mode of the grid-connected energy storage system 100, for example, whether generated power is supplied to the common grid 140, is supplied to the load 150, is stored in the battery 120, or power supplied from the common grid 140 is stored in the battery 120.

The integrated controller 114 transmits a control signal for controlling a switching operation of each of the MPPT converter 111, the two-way inverter 112, and the two-way converter 113. In this case, the control signal minimizes a loss due to power conversion of a converter or an inverter by controlling an optimum duty ratio of an input voltage of the converter or the inverter. To this end, the integrated controller 114 receives signals obtained by detecting a voltage, a current, and a temperature from an input terminal of each of the MPPT converter 111, the two-way inverter 112, and the two-way converter 113, and transmits a converter control signal and an inverter control signal based on the detected signals.

The integrated controller 114 receives grid information containing information based on a grid situation, a voltage, a current, a temperature, and so on of a grid from the common grid 140. The integrated controller 114 determines whether an abnormal situation of the common grid 140 occurs or whether power recovery occurs according to the grid information and prevents a single operation from being performed by matching controlling supplied power of the common grid 140.

The integrated controller 114 receives a state signal, that is, a charge and discharge state signal of the battery, via communication with the BMS 115 and determines an operation state of an entire system based on the charge and discharge state signal. In addition, according to the operation mode, the charge and discharge state signal of the battery 120 is transmitted to the BMS 115. The BMS 115 controls charge and discharge of the battery 120 according to the charge and discharge state signal.

The integrated controller 114 receives output power of the PV power generation system 130, which is output from MPPT converter 111, and determines whether a mismatch occurs, that is, output power of the PV power generation system 130 is smaller than the maximum output power. When a mismatch occurs, the integrated controller 114 may drive the compensation unit 160 to compensate for power input to the power managing system 110. In addition, when a mismatch is terminated, the integrated controller 114 may drive the compensation unit 160 to store power in the energy storage unit 161.

FIG. 3 is a detailed diagram of the compensation unit 160 shown in FIG. 1, according to an embodiment of the present invention.

Referring to FIG. 3, the compensation unit 160 includes a super capacitor 161 as an energy storage unit and a switching unit 162 as a controller.

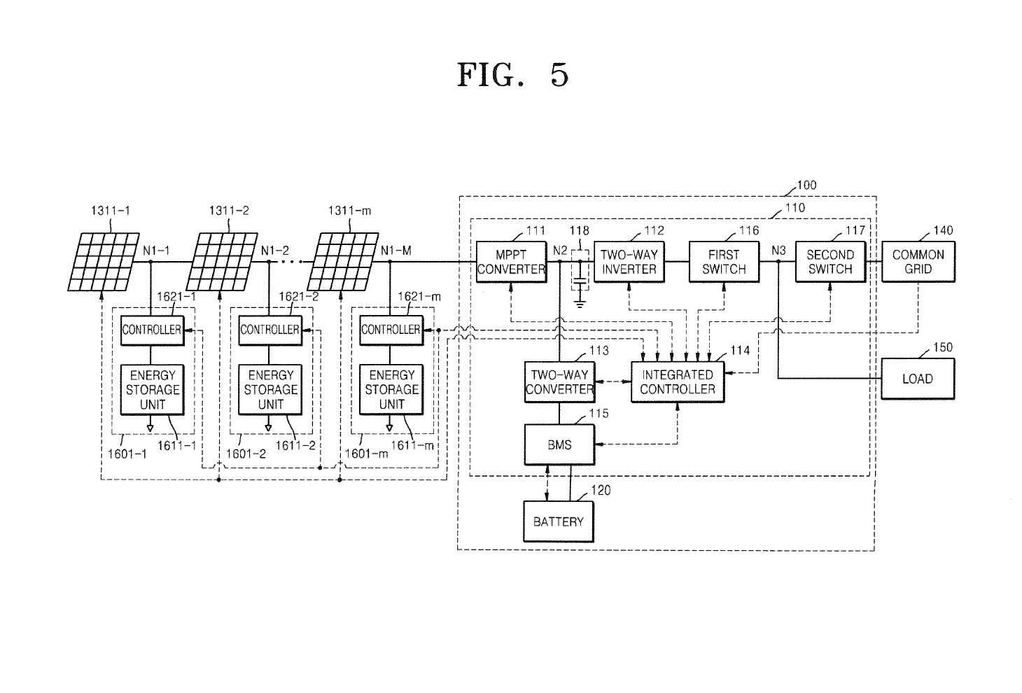

Since rate power of the solar battery module 131 is not high, the solar battery module 131 has an array structure (refer to FIGS.5, 6, and 7) in which a plurality of modules are connected in series and in parallel to each other in order to generate a great amount of power. Since the MPPT converter 111 of the power managing system 110 performs a maximum power point tracking function, the MPPT converter 111 controls the solar battery module 131 to generate a maximum output. Generally, the PV power generation system 130 is designed in such a way that solar battery modules have the same property. However, if the solar battery modules have different properties, a mismatch loss is generated, and thus, the entire output power from the solar battery modules is smaller than the sum of maximum power. The mismatch loss is generated due to errors that arise during the manufacture of the solar battery module 131, irregularity of property deterioration when the solar battery module 131 is used for a long time, dispersion of electric properties due to contamination of the solar battery module 131, shadows formed on the solar battery module 131 due to people or trees, an installation angle difference in the solar battery module 131, and environment irregularity due to a temperature difference. Due to theses reasons, alone or together, the solar battery modules may have different properties. In addition, the mismatch loss may also be generated since the solar battery modules are partially damaged or the solar battery modules having different properties are intentionally used together.

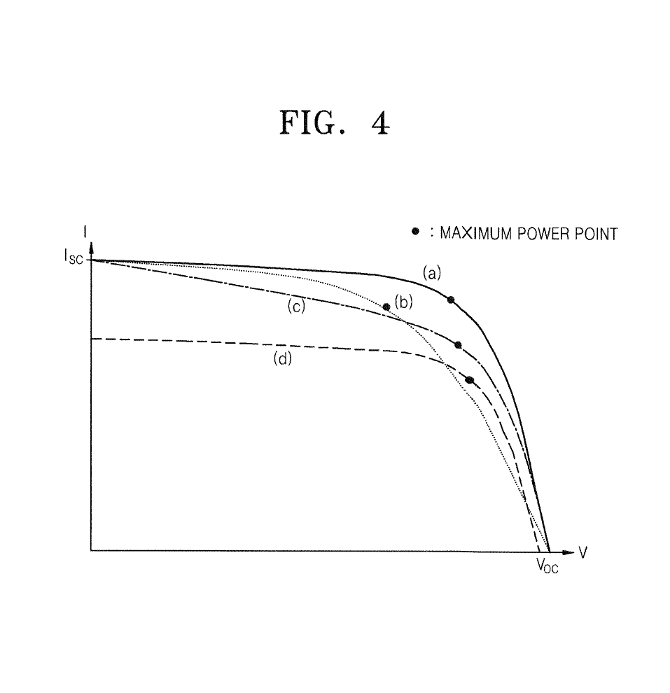

FIG. 4 is a graph showing a property change of a current-voltage curve according to a reduction in the performance of the PV power generation system 130 shown in FIG. 1, according to an embodiment of the present invention.

Referring to FIG. 4, (a) shows a current-voltage property of the solar battery module 131 in a normal state, (b) shows a current-voltage property when DC resistance is increased, (c) shows a current-voltage property when parallel resistance is increased, and (d) shows a current-voltage property when the amount of light incident on the solar battery module 131 is reduced. In cases of (b) through (d), a mismatch loss is generated. The mismatch loss reduces a generation efficiency of the PV power generation system 130 to increase a temperature of the solar battery module 131, thereby ultimately reducing a lifetime of the PV power generation system 130.

Accordingly, in order to compensate for the mismatch loss, the compensation unit 160 is used.

The super capacitor 161 of the compensation unit 160 stores and outputs power from the solar battery module 131. As the super capacitor 161 begins to be developed as a power supplier of a future electric car, the super capacitor 161 has been remarkably developed. Since a typical battery generates electric energy according to an electrochemical reaction, it takes a long time to charge the typical battery and problems in terms of environment contamination may arise. In addition, the typical battery has a very high internal resistance. On the other hand, since the super capacitor 161 is charged according to an electrical polarization action, it takes a short time to charge the super capacitor 161 and it is not likely to cause environment contamination. The super capacitor 161 may be an electrical double layer capacitor (EDLC) using an electrical double layer principle or a hybrid super capacitor using an electrochemical redox reaction. The super capacitor 161 may include a positive electrode and a negative electrode that are alternately stacked on each other, and a separator that is inserted between the stacked positive and negative electrodes and electrically separate the positive and negative electrodes from each other. The super capacitor 161 is charged and discharged via physical adsorption and desorption, has a semipermanent lifetime, a short charging time (on a second-by-second basis), a wide available temperature range (−20° C. to 70° C.), and a charge/discharge cycle of about 500,000.

The switching unit 162 of the compensation unit 160 is turned on or turned off according to control of the integrated controller 114 such that power stored in the super capacitor 161 together with power output from the solar battery module 131 is output to the power managing system 110 or power output from the solar battery module 131 is stored in the super capacitor 161.

The compensation unit 160 is connected in parallel between ground and a first node N1 that is an output terminal of the solar battery module 131. The switching unit 162 of the compensation unit 160 has one end connected to the first node N1 and the other end connected to one end of the super capacitor 161. The super capacitor 161 has one end connected to the other end of the switching unit 162 and the other end connected to ground.

When the integrated controller 114 determines that a mismatch loss is generated so that entire output power of the PV power generation system 130, which is measured by the MPPT converter 111, is smaller than the sum of maximum output power of the solar battery module 131, the integrated controller 114 outputs a control signal for turning on the switching unit 162. When the switching unit 162 is turned on, power stored in the super capacitor 161 together with power output from the solar battery module 131 is output to the power managing system 110.

When the mismatch loss is not generated any more, the integrated controller 114 outputs a control signal for turning on the switching unit 162. When the mismatch loss is not generated any more and then the switching unit 162 is turned on, power output from the solar battery module 131 is stored in the super capacitor 161 for a predetermined period of time and power output from the solar battery module 131 is output to the power managing system 110.

In a normal state, that is, when power is completely stored in the super capacitor 161 or a mismatch loss is generated, the integrated controller 114 outputs a control signal for turning off the switching unit 162. When the switching unit 162 is turned off, power output from the solar battery module 131 is output to the power managing system 110.

FIG. 5 is a block diagram of a grid-connected energy storage system 100 according to another embodiment of the present invention.

Referring to FIG. 5, compared with FIGS. 1 and 3, a plurality of solar cell modules 1311-1,1311-2, through,1311-m are connected in series to each other, and compensation units 1601-1,1601-2, through, 1601-m are connected to output nodes N1-1,N1-2, through, N1-M of the solar cell modules 1311-1,1311-2, through, 1311-m, respectively. The compensation units 1601-1, 1601-2, through, 1601-m include energy storage units 1611-1, 1611-2, through, 1611-m and controllers 1621-1, 1621-2, through, 1621-m.

In FIG. 5, when the integrated controller 114 determines that a mismatch loss is generated, the integrated controller 114 outputs a control signal for turning on only a corresponding switching unit 162 of the solar battery module 131 where the mismatch loss is generated. For example, it is assumed that a mismatch loss is generated in the solar cell module 1311-2. That is, when the mismatch loss is generated in the solar cell module 1311-2, the integrated controller 114 outputs a control signal for driving the controller 1621-2. When the controller 1621-2 operates, power stored in the energy storage unit 1611-2 is output together with power output from the solar cell modules 1311-1, 1311-2, through, 1311-m to the power managing system 110.

When the integrated controller 114 determines that the mismatch loss is not generated any more, the integrated controller 114 outputs a control signal for operating the controller 1621-2. When the mismatch loss is not generated any more and then the controller 1621-2 operates, power output from the solar cell module 1311-2 is stored in the energy storage unit 1611-2 for a predetermined period of time and power output from the solar cell modules 1311-1, 1311-2, through, 1311-m is output to the power managing system 110.

In a normal state, that is, when power is completely stored in the energy storage unit 1611-2 or a mismatch loss is generated, the integrated controller 114 outputs a control signal for not operating the controllers 1621-1, 1621-2, through, 1621-m. When the controllers 1621-1, 1621-2, through, 1621-m do not operate, power output from the solar cell modules 1311-1,1311-2, through, 1311-m is output to the power managing system 110.

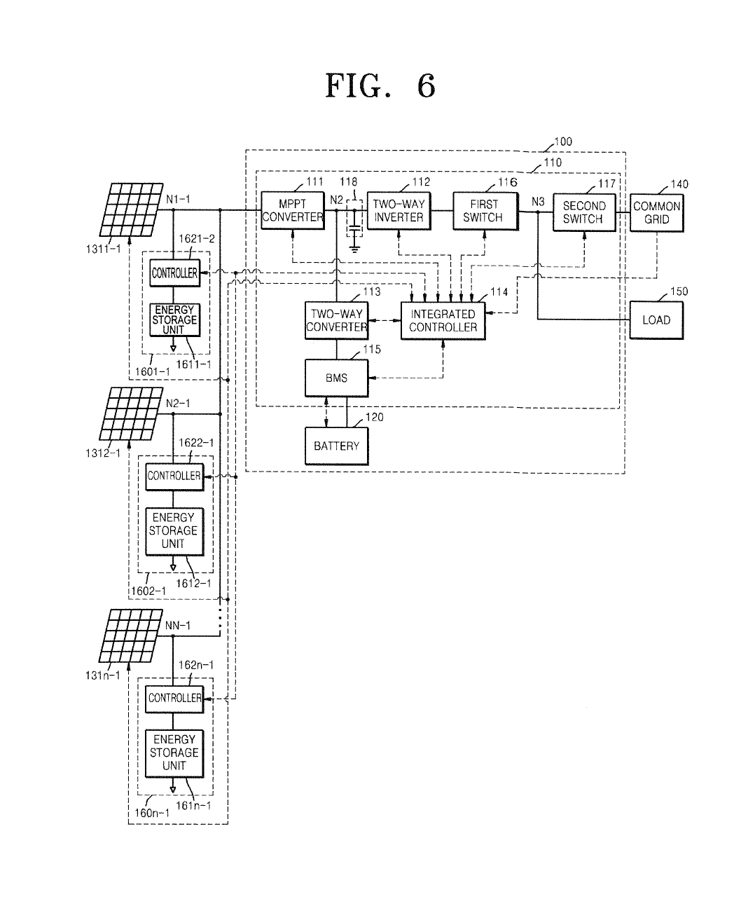

FIG. 6 is a block diagram of a grid-connected energy storage system 100 according to another embodiment of the present invention.

Referring to FIG. 6, compared with FIGS. 1 and 3, a plurality of solar cell modules 1311-1,1312-1, through, 131n-1 are connected in series to each other, and compensation units 1601-1,1602-1, through, 160n-1 are connected to output nodes N1-1, N2-1, through, NN-1 of the solar cell modules 1311-1,1312-1, through, 131n-1, respectively. The compensation units 1601-1, 1602-1, through, 160n-1 include energy storage units 1611-1, 1612-1, through, 161n-1 and controllers 1621-1, 1622-1, through, 162n-1.

In FIG. 6, when the integrated controller 114 determines that a mismatch loss is generated, the integrated controller 114 outputs a control signal for turning on only a corresponding switching unit 162 of the solar battery module 131 where the mismatch loss is generated. For example, it is assumed that a mismatch loss is generated in the solar cell module 1312-1. That is, when the mismatch loss is generated in the solar cell module 1312-1, the integrated controller 114 outputs a control signal for operating the controller 1622-1. When the controller 1622-1 operates, power stored in the energy storage unit 1612-1 is output together with power from the solar cell modules 1311-1, 1312-1, through, 131n-1 to the power managing system 110.

When the integrated controller 114 determines that the mismatch loss is not generated any more, the integrated controller 114 outputs a control signal for operating the controller 1622-1. When the mismatch loss is not generated any more and then the controller 1622-1 operates, power output from the solar cell module 1312-1 is stored in the energy storage unit 1612-1 for a predetermined period of time and power output from the solar cell modules 1311-1, 1312-1, through, 131n-1 is output to the power managing system 110.

In a normal state, that is, when power is completely stored in the energy storage unit 1612-1 or a mismatch loss is generated, the integrated controller 114 outputs a control signal for not operating the controllers 1621-1, 1622-1, through, 162n-1. When the controllers 1621-1, 1622-1, through, 162n-1 do not operate, power output from the solar cell modules 1311-1,1312-1, through, 131n-1 is output to the power managing system 110.

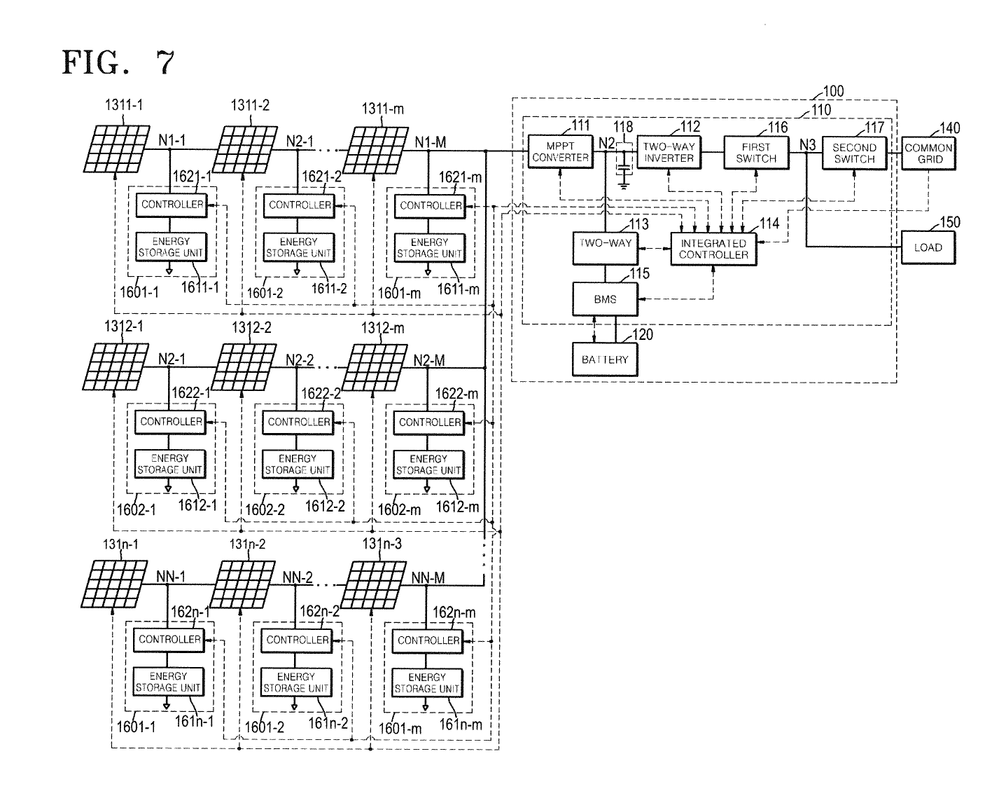

FIG. 7 is a block diagram of a grid-connected energy storage system 100 according to another embodiment of the present invention.

Referring to FIG. 7, compared with FIGS. 1 and 3, a plurality of solar cell modules 1311-1, through, 131n-m are connected in series or in parallel to each other, and compensation units 1601-1, through, 160n-m are connected to output nodes N1-1, through, NN-M of the solar cell modules 1311-1, through, 131n-m, respectively. The compensation units 1601-1, through, 160n-m include energy storage units 1611-1, through, 161n-m and controllers 1621-1, through, 162n-m.

In FIG. 7, when the integrated controller 114 determines that a mismatch loss is generated, the integrated controller 114 outputs a control signal for turning on only a corresponding switching unit 162 of the solar battery module 131 where the mismatch loss is generated. For example, it is assumed that a mismatch loss is generated in the solar cell module 1312-2. That is, when the mismatch loss is generated in the solar cell module 1312-2, the integrated controller 114 outputs a control signal for driving the controller 1622-2. When the controller 1622-2 operates, power stored in the energy storage unit 1612-2 is output together with power output by the solar cell modules 1311-1, through, 131n-m to the power managing system 110.

When the integrated controller 114 determines that the mismatch loss is not generated any more, the integrated controller 114 outputs a control signal for operating the controller 1622-2. When the mismatch loss is not generated any more and then the controller 1622-2 operates, power output from the solar cell module 1312-2 is stored in the energy storage unit 1612-2 for a predetermined period of time and power output from the solar cell modules 1311-1, through, 131n-m is output to the power managing system 110.

In a normal state, that is, when power is completely stored in the energy storage unit 1612-2 or a mismatch loss is generated, the integrated controller 114 outputs a control signal for not operating the controllers 1621-1, through, 162n-m. When the controllers 1621-1, through, 162n-m do not operate, power output from the solar cell modules 1311-1, through, 131n-m is output to the power managing system 110.

Likewise, when a mismatch loss is generated such that entire output power from the PV power generation system 130 is smaller than the sum of maximum power of the solar battery module 131, the mismatch loss of a renewable energy generation system is compensated for such that the generation efficiency of the renewable energy generation system is not reduced, thereby preventing reduction of the lifetime of the renewable energy generation system.

As described above, according to the one or more of the above embodiments of the present invention, when a mismatch loss is generated such that entire output power from a renewable energy generation system is smaller than the sum of maximum power of the renewable energy generation modules, the mismatch loss of the renewable energy generation system is compensated for such that the generation efficiency of the renewable energy generation system is not reduced, thereby preventing a reduction in a lifetime of the renewable energy generation system.

It should be understood that the exemplary embodiments described therein should be considered in a descriptive sense only and not for purposes of limitation. Descriptions of features or aspects within each embodiment should typically be considered as available for other similar features or aspects in other embodiments.

All references, including publications, patent applications, and patents, cited herein are hereby incorporated by reference to the same extent as if each reference were individually and specifically indicated to be incorporated by reference and were set forth in its entirety herein.

What is claimed is:

1. An energy storage system comprising:
a compensation unit for storing or outputting electric energy generated from a renewable energy generation system comprising a plurality of renewable energy generation modules; and
a power managing system for converting power generated from the renewable energy generation system into power for driving a load, outputting the load, and operating the compensation unit when a mismatch loss is generated whereby entire output power from the renewable energy generation system is smaller than the sum of maximum power of the renewable energy generation modules.

2. The energy storage system of claim 1, wherein the compensation unit comprises:
an energy storage unit for storing electric energy generated from the renewable energy generation system; and
a controller for outputting energy of the energy storage unit to the power managing system according to a mismatch signal generated from the power managing system.

3. The energy storage system of claim 2, wherein the controller stores electric energy in the energy storage unit according to a mismatch termination signal from the power managing system.

4. The energy storage system of claim 2, wherein the energy storage unit is a super capacitor.

5. The energy storage system of claim 4, wherein the controller is a switching unit that is turned on according to the mismatch signal generated from the power managing system and outputs energy of the energy storage unit to the power managing system.

6. The energy storage system of claim 5, wherein the compensation unit is configured in such a way that one end of the switching unit is connected to an output end of the renewable energy generation system, other end of the switching unit is connected to one end of the super capacitor, one end of the super capacitor is connected to the other end of the switching unit, and other end of the super capacitor is connected to ground.

7. The energy storage system of claim 6, wherein the switching unit is turned on for a predetermined period of time according to a mismatch termination signal so as to charge the super capacitor with the electric energy.

8. The energy storage system of claim 1, wherein the power managing system comprises:
a maximum power point tracking (MPPT) converter for measuring power generated from the renewable energy generation system and producing maximum power from the renewable energy generation system; and
an integrated controller for operating the compensation unit when a mismatch loss is generated whereby entire output power from the renewable energy generation system, which is measured by the MPPT converter, is smaller than the sum of maximum power of the renewable energy generation modules.

9. The energy storage system of claim 1, wherein the compensation unit comprises:
a plurality of energy storage units that are respectively connected to a plurality of renewable energy generation modules included in the renewable energy generation system; and
a plurality of controllers that are respectively connected to the plurality of energy storage units, and control the energy storage system to output energy of the plurality of energy storage units to the power managing system according to a mismatch signal from the power managing system.

10. The energy storage system of claim 9, wherein the power managing system operates the compensation unit corresponding to a renewable energy generation module where the mismatch loss is generated, from among the plurality of renewable energy generation modules.

11. The energy storage system of claim 10, wherein the plurality of controllers stores electric energy in an energy storage unit of a renewable energy generation module where the mismatch loss is generated, according to a mismatch termination signal from the power managing system.

12. The energy storage system of claim 9, wherein the compensation unit comprises:
a plurality of switching units having one end connected to an output terminal of each of the plurality of renewable energy generation modules of the renewable energy generation system; and
a plurality of super capacitors each having one end connected to the other end of each of the switching units and other end connected to ground.

13. The energy storage system of claim 12, wherein a switching unit connected to a renewable energy generation module where the mismatch loss is generated is turned on for a predetermined period of time according to a mismatch termination signal so as to charge a corresponding super capacitor with the electric energy.

14. An energy storage system comprising:
a plurality of compensation units that are respectively connected to a plurality of renewable energy generation modules included in a renewable energy generation system and store or output electric energy generated from the plurality of renewable energy generation modules; and
a power managing system for converting power generated from the renewable energy generation system into power for driving a load, outputting the load, and operating the compensation unit when a mismatch loss is generated whereby entire output power from the renewable energy generation system is smaller than the sum of maximum power of the renewable energy generation modules.

15. The energy storage system of claim 14, wherein the plurality of compensation units are connected in series between ground and an output terminal of the plurality of renewable energy generation modules that are configured in such as way that an input terminal of a second renewable energy generation module is connected to an output terminal of a first renewable energy generation module and an input terminal of a third renewable energy generation module is connected to an output terminal of the second renewable energy generation module.

16. The energy storage system of claim 14, wherein the plurality of compensation units are connected in parallel between ground and an output terminal of each of the plurality of renewable energy generation modules that are configured in such as way that an output terminal of another renewable energy generation module is connected to an output terminal of a first renewable energy generation module.

17. The energy storage system of claim 14, wherein the plurality of compensation units are connected in parallel between ground and an output terminal of each of the plurality of renewable energy generation modules that are configured in such as way that an input terminal of a second renewable energy generation module is connected to an output terminal of a first renewable energy generation module and an input terminal of a third renewable energy generation module is connected to an output terminal of the second renewable energy generation module.
